(19) United States
(12) Patent Application Publication
(10) Pub. No.: US 2004/0266356 A1
(43) Pub. Date: Dec. 30, 2004

(54) Multiple antenna apparatus and method to provide interference detection and cancellation

(76) Inventors: Ronald D. Javor, Phoenix, AZ (US); Malcolm H. Smith, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/607,796

(22) Filed: Jun. 27, 2003

(51) Int. Cl. H04B 17/00

(52) U.S. Cl. 455/67.11; 455/67.13; 455/575.7

(57) ABSTRACT

Briefly, in accordance with an embodiment of the invention, an apparatus and method to provide interference detection and cancellation is provided. The apparatus may include a first antenna coupled to a first receiver, and a second antenna coupled to a second receiver, wherein the second antenna has a radiation pattern different than a radiation pattern of the first antenna.

### BACKGROUND

Destructive interference due to multipath fading and interfering signals may reduce a radio's ability to receive signals. Since signals reflect off objects and may arrive at a point in space in-phase and out-of-phase, and may combine with interfering signals, this may result in destructive interference. The destructive interference may result in dead spots, where signals may not be received. Wireless designers are continually searching for alternate ways to reduce problems due to multipath fading and interfering signals.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a schematic diagram illustrating a wireless communication device in accordance with an embodiment of the present invention; and

FIG. 2 is a schematic diagram illustrating a wireless communication device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “include” and “comprise,” along with their derivatives, may be used, and are intended to be treated as synonyms for each other. In addition, in the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

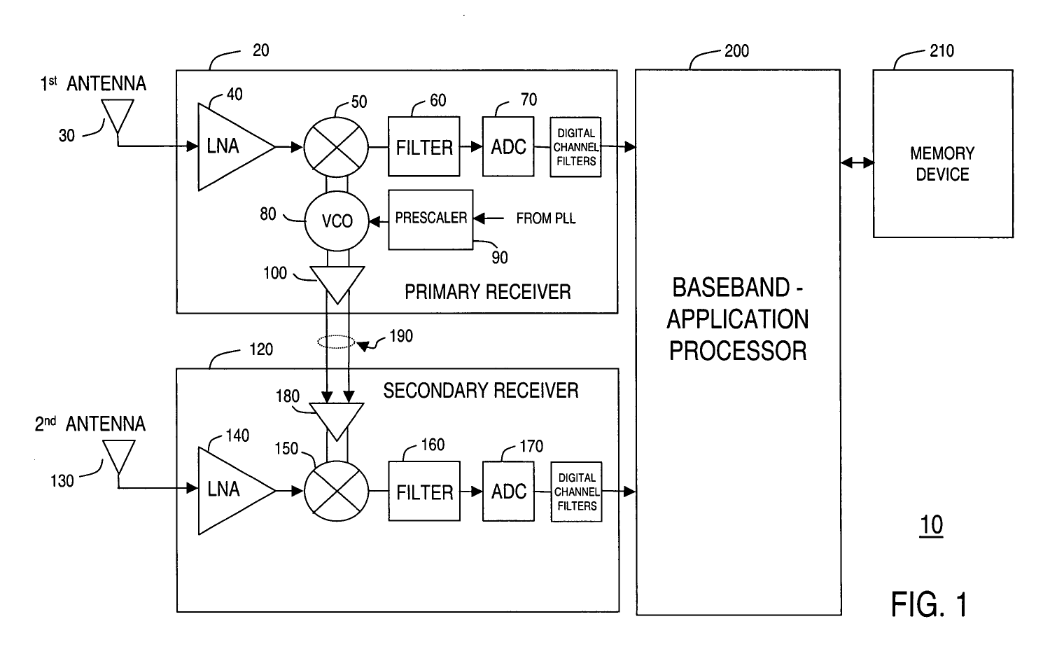

FIG. 1 illustrates features of the present invention that may be incorporated into a wireless communication device 10 such as, for example, a Global System for a Mobile Communications (GSM) portable handset. Although the receiver is shown as a direct conversion receiver, other types of receivers such as a super-heterodyne receiver or a sampling receiver may be used, and the type of receiver is not a limitation of the present invention. The receiver illustrated in FIG. 1 may also be referred to as a zero intermediate frequency (IF) receiver. An example of a sampling receiver is a RF-to-digital receiver. Further, for simplicity the circuits have been described as providing differential signals but it should be understood that single-ended signals may be used without limiting the claimed subject matter.

The transceiver either receives or transmits a modulated signal from multiple antennas 30 and 130. Shown in FIG. 1 is a multiple antenna and multiple receiver apparatus that may be used to improve a radio's resilience to multi-path fading and interfering signals, which may improve throughput.

Wireless device 10 may include a direct conversion primary receiver 20 that may include a Low Noise Amplifier (LNA) 40 having an input terminal coupled to antenna 30 for amplifying the received signal such as, for example, a received radio frequency (RF) signal. A mixer 50 translates the carrier frequency of the received modulated signal, down-converting the frequency of the modulated signal in the primary receiver. The down-converted, baseband signal may be filtered through a filter 60 and converted from an analog signal to a digital representation by an Analog-To-Digital Converter (ADC) 70. The digital representation may be passed through digital channel filters prior to being transferred to a baseband and application processor 200. In primary receiver 20, mixer 50 is further coupled to a Voltage Controlled Oscillator (VCO) 80 to receive an oscillator signal. The frequency of the signal provided by this local oscillator is determined by a prescaler 90 in dividing down a signal generated by a Phase Lock Loop (PLL).

The transceiver may further include a direct conversion secondary receiver 120 that may include a Low Noise Amplifier (LNA) 140 having an input terminal coupled to antenna 130 that amplifies another received modulated signal. A mixer 150 provides frequency translation of the carrier in the modulated signal. With the frequency of the modulated signal down-converted in the second receiver 120, the baseband signal may be filtered through a filter 160 and converted from an analog signal to a digital representation value by an Analog-To-Digital Converter (ADC) 170. The digital representation value may be passed through digital channel filters prior to being passed to a baseband and application processor 200. The processor is coupled to primary receiver 20 and to secondary receiver 120 to provide, in general, the digital processing of the received data within communications device 10.

A memory device 210 may be coupled to processor 200 to store data and/or instructions. In some embodiments, memory device 210 may be a volatile memory such as, for example, a Static Random Access Memory (SRAM), a Dynamic Random Access Memory (DRAM) or a Synchronous Dynamic Random Access Memory (SDRAM), although the scope of the claimed subject matter is not limited in this respect. In alternate embodiments, memory device 210 may be a nonvolatile memory such as, for example, an Electrically Programmable Read-Only Memory (EPROM), an Electrically Erasable and Programmable Read Only Memory (EEPROM), a flash memory (NAND or NOR type, including multiple bits per cell), a Ferroelectric Random Access Memory (FRAM), a Polymer Ferroelectric Random Access Memory (PFRAM), a Magnetic Random Access Memory (MRAM), an Ovonics Unified Memory (OUM), a disk memory such as, for example, an electromechanical hard disk, an optical disk, a magnetic disk, or any other device capable of storing instructions and/or data. However, it should be understood that the scope of the present invention is not limited to these examples.

The analog front end that includes primary receiver 20 and secondary receiver 120 may be embedded with processor 200 as a mixed-mode integrated circuit. Alternatively, primary receiver 20 and secondary receiver 120 may be a stand-alone Radio Frequency (RF) integrated analog circuit that includes low noise amplifiers, mixers, digital filters and ADCs. In yet another embodiment having a different partitioning of elements, the analog circuit may include low noise amplifiers and mixer(s), while the filters and ADCs may be included with the baseband processor. Accordingly, embodiments of the present invention may be used in a variety of applications, with the claimed subject matter incorporated with/into microcontrollers, general-purpose microprocessors, Digital Signal Processors (DSPs), Reduced Instruction-Set Computing (RISC), Complex Instruction-Set Computing (CISC), among other electronic components. In particular, the present invention may be used in smart phones, communicators and Personal Digital Assistants (PDAs), base band and application processors, medical or biotech equipment, automotive safety and protective equipment, and automotive infotainment products. However, it should be understood that the scope of the present invention is not limited to these examples.

Wireless communication device 10 may use at least two distinct receiver chains or receiver paths. In the embodiment that places the individual receiver chains on separate integrated circuits, a single synthesizer drives mixer 50 in one receiver chain in primary receiver 20 and further drives mixer 150 in another receiver chain in secondary receiver 120. The two distinct receiver chains on separate chips are used to implement a dual-antenna, dual-receiver based on a direct down conversion architecture. Thus, with VCO 80 located within primary receiver 20, the signals from the VCO are transferred through a differential output buffer, e.g. amplifier 100, to external terminals. The inputs of a differential input buffer, e.g., amplifier 180, are coupled to input terminals on secondary receiver 120, and coupled to receive signals from VCO 80 via traces 190. Thus, amplifier 100 interfaces VCO 80 on primary receiver 20 to the external environment, and to amplifier 180 on secondary receiver 120. The physical traces 190 external to the receivers may provide an environment having low noise and low signal loss. Again, the use of differential output and input amplifiers 100 and 180 allow a single VCO to drive mixers on two separate integrated circuits that may be used to implement a dual-antenna receiver, based on direct-down conversion architecture.

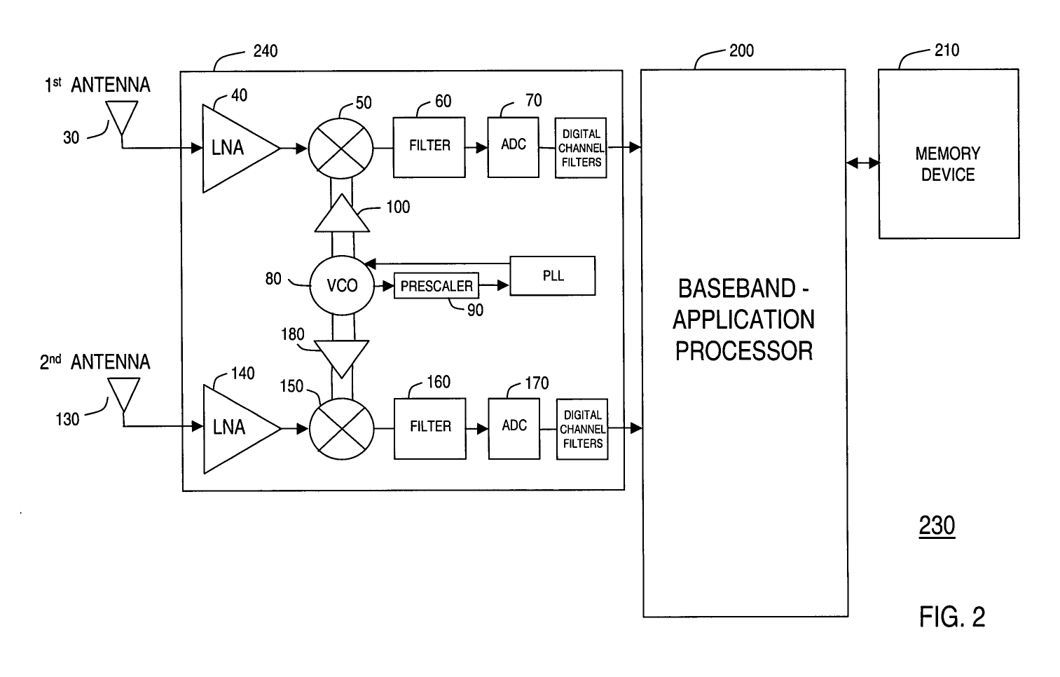

FIG. 2 illustrates features of the present invention that may be incorporated in a receiver 240 that may use at least two distinct receiver chains or paths, and at least two antennas in a wireless communication device 230. In this embodiment, the first receiver chain may include antenna 30, LNA 40, mixer 50, filter 60, ADC 70 and the digital channel filters. The second receiver chain may include antenna 130, LNA 140, mixer 150, filter 160, ADC 170 and the digital channel filters. In this embodiment both receiver chains are integrated together onto the same integrated circuit that further includes a VCO 80. VCO 80 is separated from mixers 50 and 150 by respective amplifiers 100 and 180. Note that VCO 80 is coupled to a Phase Lock Loop (PLL) that may or may not be integrated with receiver 240. Further note that in one embodiment, receiver 240 may be integrated with processor 200 onto a single chip.

Receiver 240 may provide an area and power efficient implementation of a direct-down conversion architecture having only one synthesizer to drive the mixers of both receiver chains. In this embodiment, one PLL drives VCO 80, with feedback from the VCO through a prescaler 90 to the PLL. Buffer amplifiers 100 and 180 couple the VCO signals to the respective mixers 50 and 150 of each receiver chain, where the buffer amplifiers provide additional isolation between the two receiver chains.

With reference to FIGS. 1 and 2, the first receiver chain that may include antenna 30, LNA 40, mixer 50, filter 60, ADC 70 and digital channel filters may operate in an active mode to receive a signal and provide processor 200 with quadrature signals. Likewise, the second receiver chain that may include antenna 130, LNA 140, mixer 150, filter 160, ADC 170 and digital channel filters may operate in an active mode to receive a signal and provide processor 200 with quadrature signals. However, both receive chains may be inactive for periods of time and then independently selected and enabled.

As is illustrated in FIG. 1, antennas 30 and 130 may be adapted to receive radio frequency (RF) signals. In addition to receiving signals, antenna 30 may be switchably or selectively coupled to transmit signals. For example, antenna 30 may be switchably coupled to an output terminal of power amplifier (not shown) via a switch (not shown). Antenna 30 may be referred to as a primary antenna or also as a transmit and receive (TX/RX) antenna. Antenna 130 may be referred to as a secondary antenna or a receive only (RX only) antenna.

In one embodiment, antennas 30 and 130 may be antennas having different structural types. For example, antenna 30 may be a “whip” antenna, a “stub” antenna or a dipole antenna, while antenna 130 may be a microstrip patch antenna. A microstrip patch antenna may be layer of metal, e.g., copper, over a ground plan and may be separated by an insulator material.

In one embodiment, antenna 30 may have a radiation pattern different than the radiation pattern of antenna 130. For example, antenna 30 may be an omni-directional antenna having a non-directive radiation pattern, e.g., capable of receiving signals from many angles., and antenna 130 may be a directive antenna having a directive radiation pattern, e.g., capable of receiving signals from fixed angles. A “whip” or “stub” antenna may be an omni-directional antenna and a microstrip patch antenna may be a directive antenna. In this embodiment, omni-directional antenna 30 may be used in conjunction with the directive antenna 130 to provide radiation pattern diversity. As illustrated in FIGS. 1 and 2, antennas 30 and 130 may be respectively coupled to at least two different receive paths to receive at least two different signals. This embodiment may provide processing of de-correlated signals that are received by antennas 30 and 130, and processed by the separate receive paths. These different or de-correlated signals may be processed by a digital baseband logic circuit, e.g., baseband-application processor 200. This embodiment may be used to provide interference detection and cancellation, and may improve throughput over systems not using at least two receivers and at least two antennas having different radiation pattern characteristics.

Antennas 30 and 130 may also provide “antenna diversity” to reduce problems due to destructive interference from multipath fading or interference signals. Antennas 30 and 130 may be separated by a predetermined distance, e.g., at least about two centimeters (cm), to provide antenna diversity. The spatial separation of antennas 30 and 130 may decrease the likelihood that both antennas 30 and 130 receive the same combination of multipath-faded or interfering signals.

Although wireless devices 10 and 230 are illustrated with two antennas and two receive paths to receive two signals not correlated to each other, this is not a limitation of the present invention. The principles of the present invention may be applied using more than two antennas and more than two receive paths to receive more than two signals.

In one embodiment, devices 10 and 230 may be cellular telephones. In this embodiment, a portion of antenna 30 may be external to the housing of devices 10 or 230 and antenna 130 may be internal to the housing of devices 10 and 230.

Although the scope of the present invention is not limited in this respect, wireless communication devices 10 and 230 may be adapted to process a variety of wireless communication protocols such wireless personal area network (WPAN) protocols, wireless local area network (WLAN) protocols, wireless metropolitan area network (WMAN) protocols, or wireless wide area network (WWAN) protocols.

Although the scope of the present invention is not limited in this respect, wireless communication devices 10 and 230 may be each be a wireless telephone, a personal digital assistant (PDA), a laptop or portable computer with wireless capability, an wireless local area network (WLAN) access point (AP), a web tablet, a pager, an instant messaging device, a digital music player, a digital camera, or other devices that may be adapted to transmit and/or receive information wirelessly. In other embodiments, devices 10 and 230 may be a set-top box, a gateway, or a multimedia center with wireless capability. The gateway may include a digital subscriber line (DSL) modem or a cable modem, and a router. The multimedia center may include a personal video recorder (PVR) and a digital video disc (DVD) player.

Wireless devices 10 and 230 may be used in any of the following systems: a wireless personal area network (WPAN) system, a wireless local area network (WLAN) system, a wireless metropolitan area network (WMAN), or wireless wide area network (WWAN) system, although the scope of the present invention is not limited in this respect. An example of WLAN system includes the Industrial Electrical and Electronics Engineers (IEEE) 802.11 standard. An example of a WMAN system includes the Industrial Electrical and Electronics Engineers (IEEE) 802.16 standard. An example of a WPAN system includes Bluetooth™ (Bluetooth is a registered trademark of the Bluetooth Special Interest Group). Examples of cellular systems include: Code Division Multiple Access (CDMA) cellular radiotelephone communication systems, Global System for Mobile Communications (GSM) cellular radiotelephone systems, Enhanced data for GSM Evolution (EDGE) systems, North American Digital Cellular (NADC) cellular radiotelephone systems, Time Division Multiple Access (TDMA) systems, Extended-TDMA (E-TDMA) cellular radiotelephone systems, GPRS, third generation (3G) systems like Wide-band CDMA (WCDMA), CDMA-2000, Universal Mobile Telecommunications System (UMTS), or the like.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a first antenna coupled to a first receiver; and
a second antenna coupled to a second receiver and having a radiation pattern different than a radiation pattern of the first antenna.

2. The apparatus of claim 1, wherein the first antenna is an omni-directional antenna having a non-directive radiation pattern and wherein the second antenna is a directive antenna having a directive radiation pattern

3. The apparatus of claim 1, wherein the first antenna is a whip antenna, stub antenna, or dipole antenna.

4. The apparatus of claim 1, wherein the second antenna is a microstrip patch antenna.

5. The apparatus of claim 1, wherein the first receiver comprises a first low noise amplifier (LNA) having an input terminal coupled to the first antenna and wherein the second receiver is separate from the first receiver and comprises a second low noise amplifier (LNA) having an input terminal coupled to the second antenna.

6. The apparatus of claim 1, wherein the first receiver is a direct conversion receiver and wherein the second receiver is a direct conversion receiver.

7. The apparatus of claim 1, further comprising a baseband processor coupled to the first receiver and the second receiver.

8. The apparatus of claim 1, wherein the first antenna receives a first radio frequency (RF) signal and the second antenna receives a second radio frequency (RF) signal that is not correlated to the first signal and further comprising a baseband logic circuit adapted to process the first radio frequency (RF) signal and the second radio frequency (RF) signal to provide interference detection and cancellation.

9. The apparatus of claim 1, wherein the first receiver is adapted to down convert a first signal from the first antenna and wherein the second receiver is adapted to down convert a second signal from the second antenna.

10. A system, comprising:
a wireless wide area network (WWAN) device, comprising:
a first antenna coupled to a first receiver; and
a second antenna coupled to a second receiver and having a radiation pattern different than a radiation pattern of the first antenna.

11. The system of claim 10, wherein the wireless wide area network (WWAN) is a cellular telephone.

12. The system of claim 11, wherein at least a portion of the first antenna is external to a housing of the cellular telephone and wherein the second antenna is internal to the housing of the cellular telephone.

13. The system of claim 10, wherein the first antenna is an omni-directional antenna having a non-directive radiation pattern and wherein the second antenna is a directive antenna having a directive radiation pattern.

14. A method, comprising:
receiving a first signal from a first antenna at the input terminal of a first receiver; and
receiving a second signal different from the first signal from a second antenna at the input terminal of a second receiver, wherein the radiation pattern of the first antenna is different than the radiation pattern of the second antenna.

15. The method of claim 14, further comprising:
downconverting the first signal to a first baseband signal; and
downconverting the first signal to a second baseband signal.

16. The method of claim 14, wherein receiving a first signal comprises receiving the first signal from an omni-directional antenna having a non-directive radiation pattern.

17. The method of claim 16, wherein receiving the first signal from an omni-directional antenna includes receiving the first signal from a whip antenna.

18. The method of claim 14, wherein receiving a second signal comprises receiving the second signal from a directive antenna having a directive radiation pattern.

19. The method of claim 18, wherein receiving the second signal from a directive antenna comprises receiving the second signal from a microstrip patch antenna.
